(19) United States
(12) Patent Application Publication
(10) Pub. No.: US 2023/0249112 A1
(43) Pub. Date: Aug. 10, 2023

(54) AIR INTAKE FILTER RETAINER FOR DATACENTERS

(71) Applicant: Scot Arthur Johnson, Woodview (CA)

(72) Inventor: Scot Arthur Johnson, Woodview (CA)

(21) Appl. No.: 18/105,939

(22) Filed: Feb. 6, 2023

Related U.S. Application Data
(60) Provisional application No. 63/307,304, filed on Feb. 7, 2022.

(51) Int. Cl. B01D 46/00; B01D 46/58; F24F 13/28

(52) U.S. Cl. CPC B01D 46/0005; B01D 46/58; F24F 13/28

(57) ABSTRACT

A retaining element for multiple air filters of an air intake awning assembly for a datacenter is described. The retaining element comprises a first set of members extending along a first axis; and a second set of members extending along a second axis, and defining one or more openings between the members. The members are spaced to overlie boundaries between adjacent air filters of the multiple air filters when the retaining element is disposed above the multiple air filters.

### REFERENCE TO RELATED APPLICATIONS

This application claims the benefit of U.S. Provisional Application No. 63/307,304 filed on Feb. 7, 2022, the entire contents of which is incorporated herein by reference.

### FIELD

The described embodiments relate to retaining elements for air filters used in air intake assemblies of datacenters.

### BACKGROUND

Many datacenters have very high power requirements and can require substantial cooling to maintain computing equipment within its acceptable operating conditions. Active cooling (i.e., using a chiller, condenser, pump, cooling towers, etc.) is one commonly used option for cooling the datacenter. This approach has drawbacks however, including high electrical power requirements, high equipment costs, and high maintenance costs.

It can be advantageous to locate such datacenters in geographical locations with cold ambient air temperatures. An air flow system of the datacenter can use the cold ambient air as input for cooling the datacenter and exhaust heated air into the atmosphere. The use of the cold ambient air for cooling can help reduce the power consumption of the datacenter. In such environments, snow may be present in the air. In other environments, dirt, dust and other contaminant may be present in the air. Multiple air filters may be positioned at the input of the air flow system to filter the external air introduced into the datacenter. The air filters can help reduce the flow of dirt, dust, snow and other particulate matter and contaminants from the external environment into the datacenter.

### SUMMARY

In accordance with an aspect of the invention, some embodiments provide a retaining element for multiple air filters of an air intake awning assembly for a datacenter. The retaining element comprises a first set of members extending along a first axis; a second set of members extending along a second axis, and defining one or more openings between the members. The members are spaced to overlie boundaries between adjacent air filters of the multiple air filters when the retaining element is disposed above the multiple air filters.

In at least one embodiment, the first axis and the second axis may be perpendicular to each other.

In at least one embodiment, the multiple air filters may include two or more air filters disposed adjacent to each other along the first axis.

In at least one embodiment, the retaining element may further include a clip element adapted to attach the retaining element to the air intake awning assembly.

In at least one embodiment, the retaining element may be pivotably hinged to the air intake awning assembly.

In at least one embodiment, the retaining element may include one or more holes to attach the retaining element to the air intake awning assembly using one or more fasteners.

In at least one embodiment, the air intake assembly may include a first end comprising an intake opening corresponding to an air inlet of the datacenter and a second end adapted to retain the multiple air filters in a plane perpendicular to the first end.

In at least one embodiment, the air intake awning assembly may further comprise one or more rib elements extending along the first axis disposed between air filters of the multiple air filters adjacent to each other along the second axis; and wherein one or more of the first set of members of the retaining element overlie the rib elements.

### BRIEF DESCRIPTION OF THE DRAWINGS

Various preferred embodiments of the present invention will now be described in detail with reference to the drawings, in which:

FIG. 1 is a perspective view of an example datacenter;

FIG. 2 is another perspective view of the datacenter of FIG. 1;

FIG. 3 is a cutaway top view of the datacenter of FIG. 1;

FIG. 4A is a perspective view of an example air intake awning assembly;

FIG. 4B is an exploded perspective view of the air intake awning assembly of FIG. 4A;

FIG. 4C illustrates a side view of the air intake awning assembly of FIG. 4A attached at an air inlet of the datacenter of FIG. 1;

FIG. 4D illustrates a top view of three air intake awning assemblies, like the one shown in FIG. 4A, attached at three air inlets of the datacenter of FIG. 1;

FIG. 5A is a perspective view of an example retaining element;

FIG. 5B is a side view of the retaining element of FIG. 5A;

FIG. 5C is a top view of the retaining element of FIG. 5A;

FIG. 6A is a perspective view of the retaining element of FIG. 5A disposed in the air intake awning assembly of FIG. 4A;

FIG. 6B is an exploded perspective view of the retaining element of FIG. 5A disposed in the air intake awning assembly of FIG. 4A.

### DESCRIPTION OF EXEMPLARY EMBODIMENTS

Several example embodiments are described below. Numerous specific details are set forth in order to provide a thorough understanding of the example embodiments. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Datacenters using an air flow system for cooling may include multiple air filters positioned at each air inlet of the datacenter. An air intake awning assembly may be used to retain the air filters in position. The air filters can help reduce the flow of dirt, dust and other particulate matter and contaminants from the external environment into the datacenter. To enable installation and removal of the air filters, a clearance may be provided between adjacent air filters, and between the air filters and the structural components of the air intake awning assembly. When air from the external environment is pulled into the datacenter, moisture in the form of rain, snow or other precipitation may enter the datacenter through the clearance provided for the air filters. The equipment inside the datacenter may be sensitive to the moisture entering the datacenter and the introduced moisture may cause damage to the equipment inside the datacenter. Additional maintenance equipment and/or maintenance activities may be required for the removal of the introduced moisture from the datacenter.

The embodiments described herein provide a retaining element for multiple air filters of an air intake awning assembly for a datacenter. The retaining element comprises a first set of members extending along a first axis and a second set of members extending along a second axis. The members are spaced to overlie boundaries between adjacent air filters of the multiple air filters when the retaining element is disposed above the multiple air filters. The members can block a portion of the rain, snow and other forms of precipitation from entering the datacenter through the clearance provided for the air filters. This may help protect the equipment inside the datacenter and reduce the need for additional maintenance equipment and/or maintenance activities.

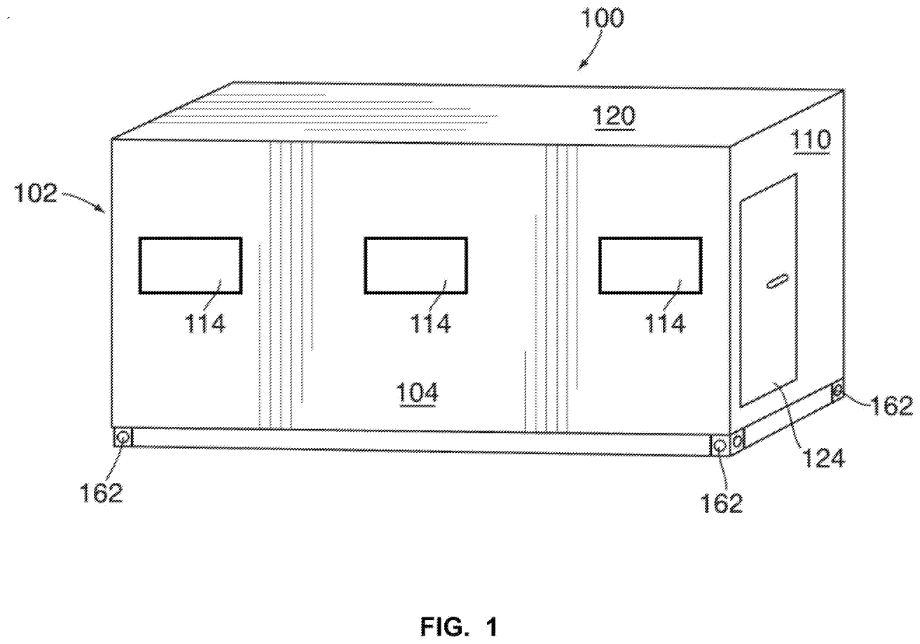

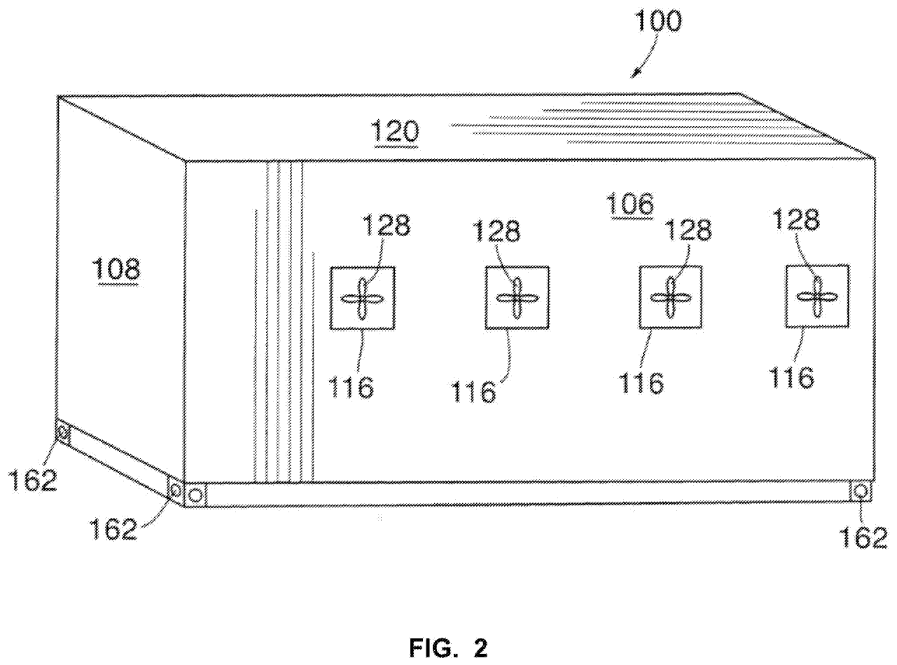

Reference is first made to FIGS. 1-3, which illustrate a datacenter 100. Datacenter 100 includes a housing 102. In some examples, housing 102 may be a non-transportable structure. For the illustrated example, housing 102 is a transportable shipping container having sidewalls 104 and 106, end walls 108 and 110, a floor 118 and a ceiling or roof 120. Housing 102 may be a typical shipping container suitable for transport by truck, rail or boat. Housing 102 can typically be made of rigid, weather-resistant material capable of withstanding an outdoor environment. Housing 102 of datacenter 100 may provide a generally weather-resistant and enclosed volume in which other elements of datacenter 100 may be installed. In some embodiments, housing 102 may be a freight container or a transportable intermodal container compliant with a corresponding standard such as ISO 668 or ISO 1496. In some examples, multiple datacenters may be stackable one atop another.

Datacenter 100 includes an air flow system for cooling the processors that may be installed inside the datacenter. Air flow is provided through datacenter 100 by air flowing into one or more air inlets of the datacenter, and through the datacenter to an air exhaust, typically from one sidewall of the datacenter to the opposing sidewall. In datacenter 100, air flow is provided from sidewall 104 to sidewall 106. Sidewall 104, having the air inlets, may be referred to as the inlet side. Sidewall 106, having the air exhaust, may be referred to as the exhaust side.

Sidewall 104 includes one or more air inlets 114 to allow intake of cool air from the environment. Each air inlet 114 will typically have a filter or other protective element installed in the inlet opening to reduce the flow of dirt, dust and other particulate matter and contaminants into datacenter 100. In some embodiments, some or all of air inlets 114 may have an air intake fan installed within them. Air inlets 114 may be sized identically or differently from one another. Datacenter 100 shown in FIG. 1 includes three air inlets 114 arranged in a single row. In some embodiments, datacenter 100 may include air inlets arranged in multiple rows. For example, datacenter 100 may include a total of eight air inlets arranged in two rows of four air inlets each.

End wall 110 may have a door 124 that allows operator access into datacenter 100, typically into a cold air plenum 154.

Sidewall 106 includes one or more air exhaust openings 116 to exhaust hot air from within datacenter 100 to the environment. Each exhaust opening 116 may typically include an exhaust fan 128 installed within it. Exhaust openings 116 may be sized identically or differently from one another.

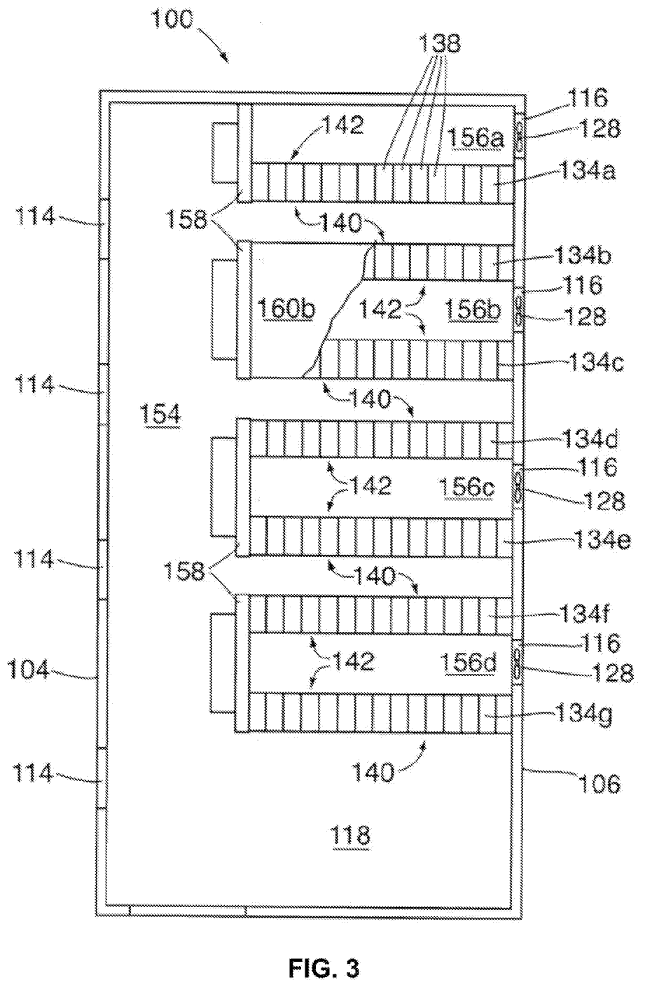

During operation, multiple processors may be installed inside datacenter 100. Different configurations may be used for installing the multiple processors inside datacenter 100 and FIG. 3 provides one example configuration.

In the example illustrated in FIG. 3, multiple racks are installed in the interior of datacenter 100. While seven racks are shown in this example, other numbers of racks can similarly be installed in the datacenter. Each rack 134 extends from a hot air plenum barrier 158 to exhaust sidewall 106. Each rack 134 has a plurality of shelves, with each shelf having a plurality of processor bays 138 having a front face 140 and a rear face 142. In operation, a processor may be installed in each of the processor bays 138. Front face 140 of each processor bay 138 opens into a cold air plenum 154 (which may also be referred to as a cold air zone). Rear face 142 of each processor bay 138 opens into a hot air plenum 156 (which may also be referred to as a hot air zone). Hot air plenums 156 may be substantially fluidically isolated from cold air plenum 154 so that warmed air exiting rear face 142 does not substantially mix with cold air that has not yet reached front face 140 when the air flow system is in operation. The air flow system progressively draws air from the environment of datacenter 100, through air inlets 114, cold air plenum 154, processor bays 138, hot air plenums 156 and then through exhaust openings 116 back to the environment of datacenter 100.

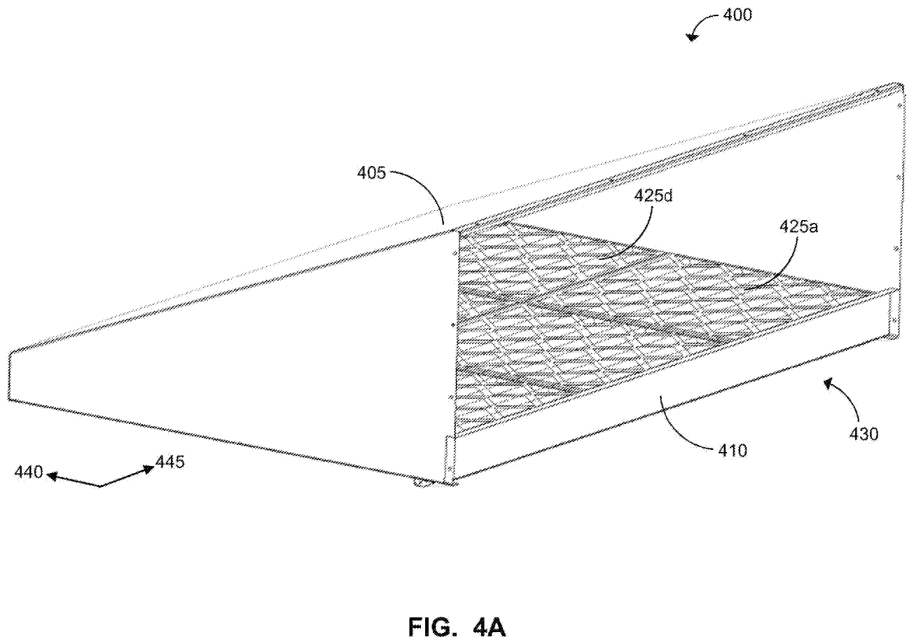

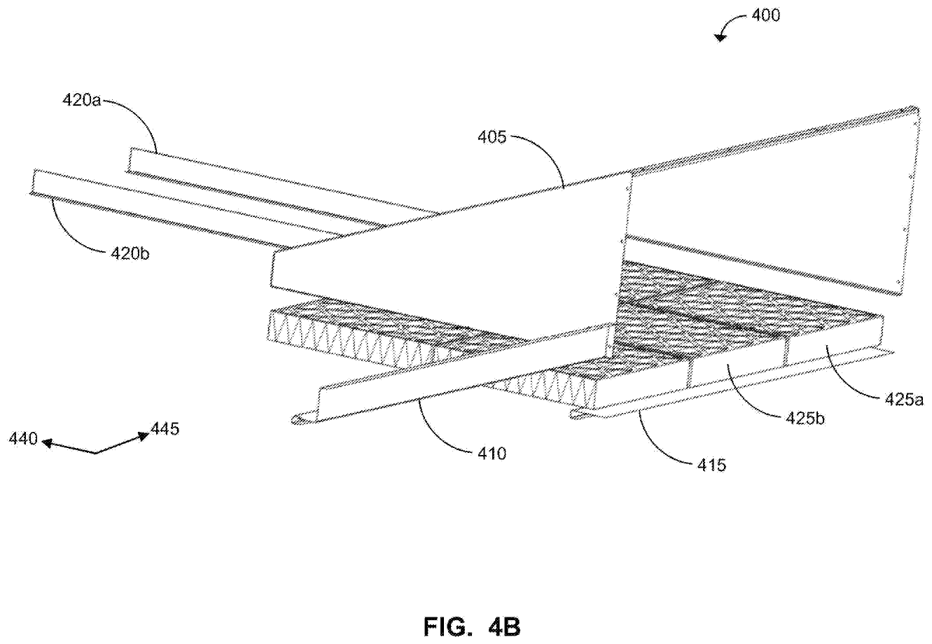

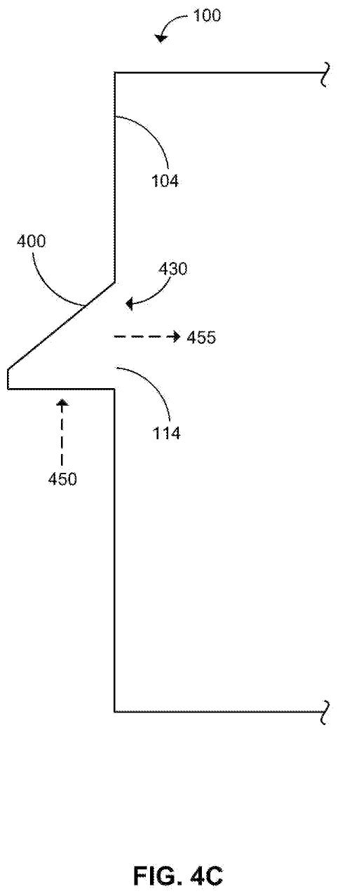

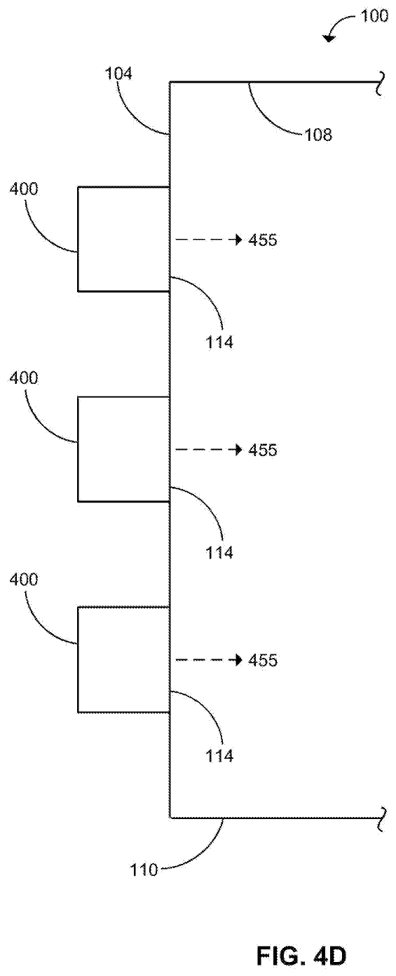

Reference is next made to FIGS. 4A-4D, which illustrate an air intake awning assembly 400. FIG. 4C further illustrates air intake awning assembly 400 attached at one of air inlets 114 of datacenter 100. Additionally, FIG. 4D illustrates an air intake awning assembly 400 attached at each of the three air inlets 114 of datacenter 100. Air intake awning assembly 400 includes a support element 405, a front closure element 410, and a front support element 415. Air intake awning assembly 400 may typically be made of rigid, weather-resistant material capable of withstanding an outdoor environment.

Support element 405 may include a first end comprising an intake opening 430. Air intake awning assembly 400 may be attached to datacenter 100 so that intake opening 430 is aligned with air inlet 114.

Support element 405 may include a second end adapted to retain multiple air filters. For the example illustrated in FIGS. 4A-4D, the second end is adapted to retain air filters in a plane perpendicular to the first end. In other embodiments, the second end may be adapted to retain air filters in a plane at an oblique angle to the first end.

In some embodiments, the surface area of the second end may be larger than the first end. During operation, the air filters placed in the second end may increase resistance to air flow 450 at the second end compared with the resistance to air flow 455 at the first end. The larger surface area of the second end may help compensate for the increased air flow resistance of the air filters.

Front closure element 410 may be removably attached to support element 405 to enable air filters 425 to be placed in and removed from air intake awning assembly 400.

For the example illustrated in FIGS. 4A-4D, six air filters 425 can be positioned in the air intake awning assembly. The six air filters may be installed in three rows, each row extending along a first axis 440 and including two air filters. In other examples, the air intake awning assembly may be configured for fewer or greater than six air filters. For example, the air intake awning assembly may be configured for a single row that extends along first axis 440 and includes three air filters. In another example, the air intake awning assembly may be configured for four rows with each row extending along first axis 440 and including three air filters for a total of twelve air filters.

Air intake awning assembly 400 may also include one or more rib elements 420 extending along first axis 440. Each rib element 420 may be disposed between two adjacent rows of air filters and separate two air filters that are adjacent to each other along a second axis 445. In some embodiments, the air intake awning assembly may not include any rib elements. For example, an air intake awning assembly that is configured for a single row of air filters may not include any rib elements.

When air filters 425 are placed in air intake awning assembly 400, the combination of support element 405, front support element 415 and any rib elements 420 support the air filters and retain them in place. To enable installation and removal of the air filters, a clearance may be provided between adjacent air filters, and between the air filters and the corresponding support element 405, front support element 415, or rib elements 420.

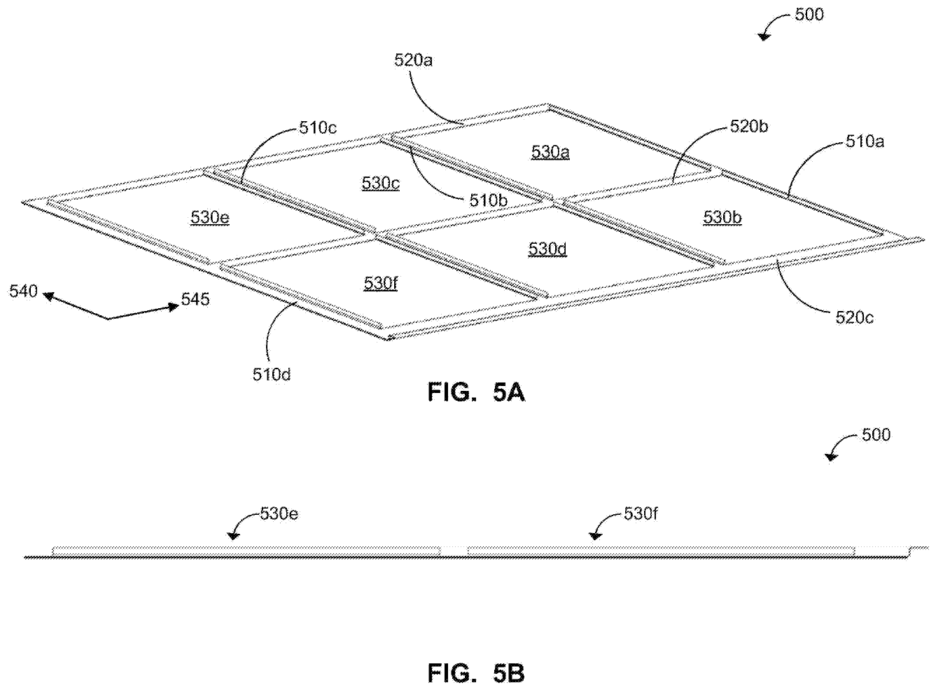

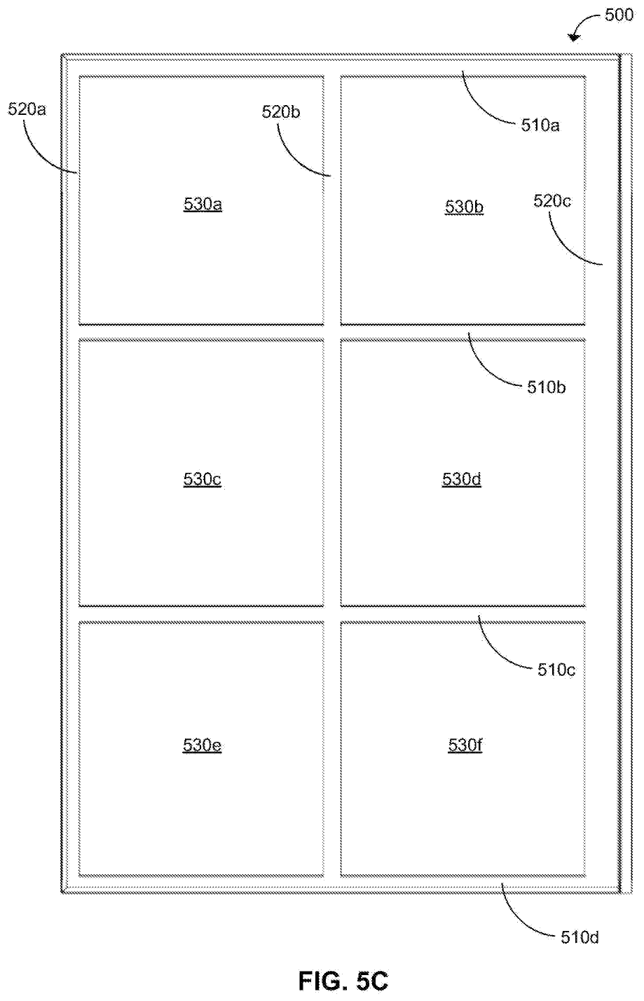

Reference is next made to FIGS. 5A-5C, which illustrate a retaining element 500. Retaining element 500 includes a first set of members 510a-510d extending along a first axis 540, a second set of members 520a-520c extending along a second axis 545, and openings 530a-530f defined between the members. In some embodiments, first axis 540 and second axis 545 may be perpendicular to each other. In other embodiments, first axis 540 and second axis 545 may be at an oblique angle to each other.

In some embodiments, the retaining element may include fewer or great number of members in the first and second set of members. The number of members in each of the first and second set of members may correspond to the air filter configuration of the air intake awning assembly. For the example air intake awning assembly 400 configured to retain six air filters, the example retaining element 500 may include four members 510a-510d in the first set of members and three members 520a-520c to provide six openings 530a-530f corresponding to the six air filters 425. Further, the spacing between the members may correspond to the size of the air filters. The members may be spaced to overlie the boundaries between the air filters when the retaining element is disposed above the air filters in the air intake awning assembly.

Retaining element 500 may be made of a rigid material such as aluminum or steel. Any other suitable material may be used for making retaining element 500 depending on any particular requirements of the air intake awning assembly or the environment of the datacenter. In some embodiments, retaining element 500 may be a single piece of material that is bent, formed or cast. In other embodiments, retaining element 500 may be formed from more than one piece, for example, using fasteners or by welding.

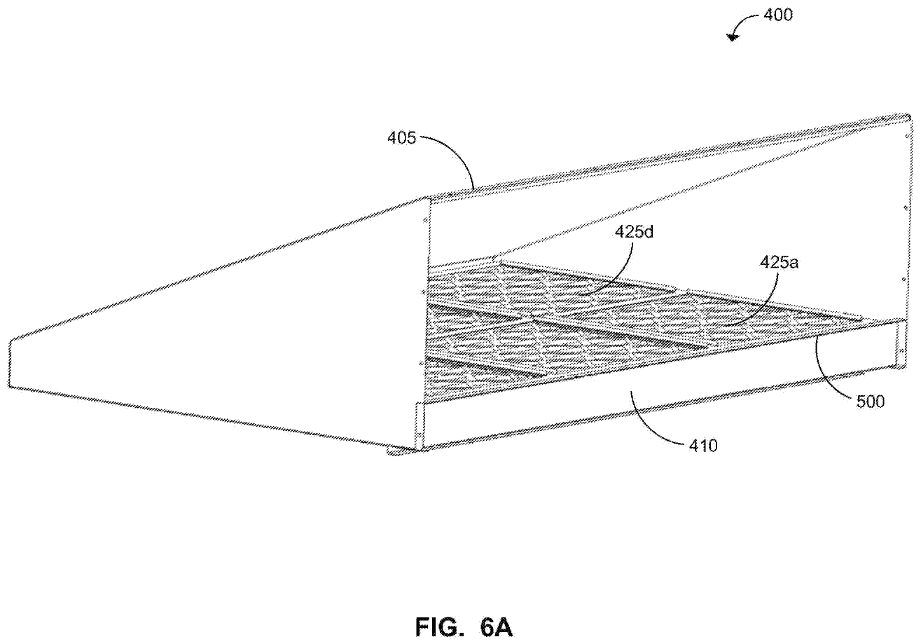

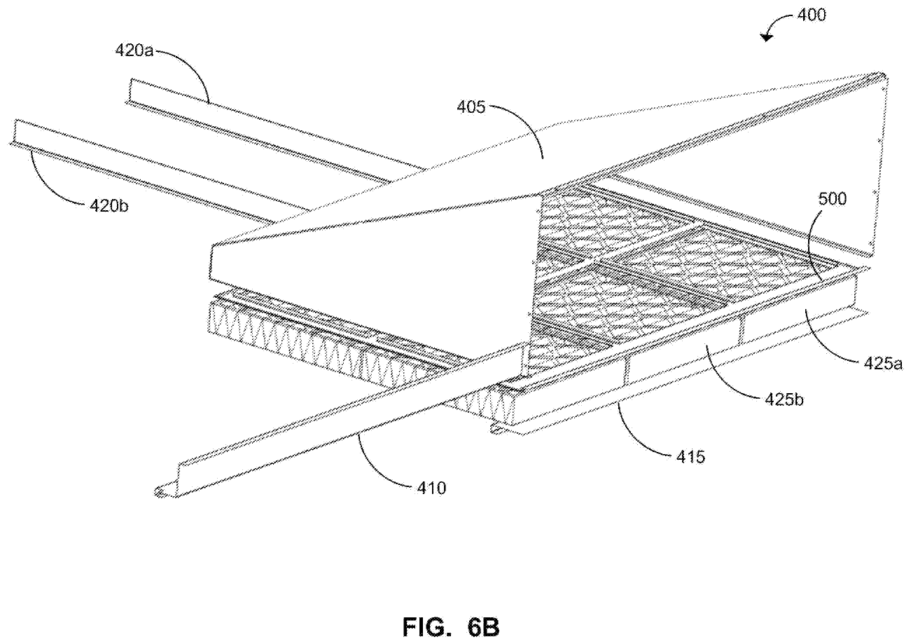

Reference is next made to FIGS. 6A and 6B, which illustrate retaining element 500 disposed in air intake awning assembly 400. Retaining element 500 may be disposed above air filters 425. Air filters 425 may support a portion of the weight of retaining element 500.

Retaining element 500 may include a clip element adapted to attach the retaining element to air intake awning assembly 400. In some embodiments, retaining element 500 may include one or more holes to attach retaining element 500 to air intake awning assembly 400 using one or more fasteners. Attaching retaining element 500 to air intake awning assembly 400 may help inhibit movement of retaining element 500 during operation. In some embodiments, retaining element 500 may be pivotably hinged to support element 405 of air intake awning assembly 400. This may enable lifting up of retaining element 500 for easier placement and removal of air filters 425 in air intake awning assembly 400.

Retaining element 500 may be disposed in air intake awning assembly 400 with openings 530a-530f aligned with air filters 425. The members of retaining element 500 may be spaced to overlie boundaries between adjacent air filters of air filters 425. Accordingly, the members may block a portion of the rain, snow and other forms of precipitation, as well as other contaminants, from entering the datacenter through the clearance provided for air filters 425. This may help protect datacenter 100 from moisture and reduce the need for additional maintenance equipment and/or maintenance activities. In embodiments of air intake awning assembly 400 that include one or more rib elements 420, one or more of first set of members 510a-510d may also overlie rib elements 420.

The present invention has been described here by way of example and with reference to several example embodiments. These embodiments are merely exemplary and do not limit the scope of the invention, which is limited only by claims.

I claim:

1. A retaining element for multiple air filters of an air intake awning assembly for a datacenter, the retaining element comprising:
a first set of members extending along a first axis;
a second set of members extending along a second axis, and defining one or more openings between the members; and
wherein the members are spaced to overlie boundaries between adjacent air filters of the multiple air filters when the retaining element is disposed above the multiple air filters.

2. The retaining element of claim 1 wherein the first axis and the second axis are perpendicular to each other.

3. The retaining element of claim 1 wherein the multiple air filters include two or more air filters disposed adjacent to each other along the first axis.

4. The retaining element of claim 1 further including a clip element adapted to attach the retaining element to the air intake awning assembly.

5. The retaining element of claim 1 wherein the retaining element is pivotably hinged to the air intake awning assembly.

6. The retaining element of claim 1 further including one or more holes to attach the retaining element to the air intake awning assembly using one or more fasteners.

7. The retaining element of claim 1 wherein the air intake assembly includes a first end comprising an intake opening corresponding to an air inlet of the datacenter and a second end adapted to retain the multiple air filters in a plane perpendicular to the first end.

8. The retaining element of claim 1 wherein the air intake awning assembly further comprises one or more rib elements extending along the first axis disposed between air filters of the multiple air filters adjacent to each other along the second axis; and wherein one or more of the first set of members of the retaining element overlie the rib elements.
